(19) United States
(12) Patent Application Publication
(10) Pub. No.: US 2013/0198010 A1
(43) Pub. Date: Aug. 1, 2013

(54) Method for producing a media production whose profits are collected prior to the production thereof so that it can be provided and/or shown to the audience for free

(71) Applicant: Francesco Gasperoni, Roma (IT)

(72) Inventor: Francesco Gasperoni, Roma (IT)

(21) Appl. No.: 13/374,974

(22) Filed: Jan. 26, 2012

(51) Int. Cl. G06Q 30/02

(52) U.S. Cl. 705/14.69

(57) ABSTRACT

Method for producing a media production that can be shown for free because its production cost and profit for the production company are covered up-front. This is achieved by selling one or more portions of screen space of the media production. Each portion is indelibly watermarked with a buyer's logo(s) and/or name(s) so as to always be visible on the media production. The screen portions are sold to entities wanting visibility and advertising space. The actual production is not commenced until the number of screen portions sold cover the estimated cost and pre-set profit of the media production. Since the sale of screen space covers the entire cost and profit of the media production, the media production with embedded names(s) and/or logo(s) is distributed free of charge via the Internet or other media for viewing online, downloading, or viewing by any means (e.g., television set).

### RELATED APPLICATION

This application is related to patent Pub. No.: US 2006/0259312 Al De Titta Pub. Date: Nov. 16, 2006 entitled “METHODS AND APPARATUS FOR PRODUCING AND FINANCING MEDIA PRODUCTIONS” and is incorporated herein by reference.

This application is also related to patent Pub. No.: US 2006/0026059 Al Feb. 2, 2006 entitled “ADVERTISING METHOD FOR DIGITALLY RENTED MOVIES” and is incorporated herein by reference.

### FIELD OF THE INVENTION

The present invention relates generally to the production and distribution systems of media productions, and more particularly, to a method for the creation of a media production whose cost and profits are completely covered by pre-selling the screen portions of such media productions to companies and/or individuals prior to the actual production thereof. The names and/or brands of these buyers will be indeleably watermarked in the aforementioned screen portion/s. The media production will then be subsequently provided free of charge to the public, for example through the internet.

### BACKGROUND OF THE INVENTION

### Introduction

Any discussion of the prior art throughout the specification should in no way be considered as an admission that such prior art is widely known or forms part of common general knowledge.

As used herein, the term media (singular medium) are the storage and transmission channels or tools used to store and deliver information or data. It is often referred to as synonymous with mass media or news media, but may refer to a single medium used to communicate any data for any purpose. For example, television, radio, and the internet are different types of media.

A Feature Film, in the film industry, is a film production made for initial distribution in theaters and being the main attraction of the screening, rather than a short film screened before it; a full length movie. The term is also used for feature length, direct-to-video and television movie productions, such as an episode of a TV series that has been extended to the length of a feature film, usually series pilots, holiday specials or season finales. Feature length is motion picture terminology referring to the length of a feature film: a Feature length film, according to the rules of the Academy of Motion Picture Arts and Sciences, is a motion picture that has a running time of more than 40 minutes.

As used herein the term Boxoffice is the amount of money received from the ticket sales of a screened media production.

As used herein, the term Low-Budget Film is a motion picture shot with little or no funding from a major film studio or private investor.

As used herein, the term short film is any film not long enough to be considered a feature film. No consensus exists as to where that boundary is drawn: the Academy of Motion Picture Arts and Sciences defines a short film as “an original motion picture that has a running time of 40 minutes or less, including all credits”.

As used herein, the term tv series (also called serials) are series of television programs that rely on a continuing plot that unfolds in a sequential episode by episode fashion. Serials typically follow main story arcs that span entire television seasons or even the full run of the series, which distinguishes them from traditional episodic television that relies on more stand-alone episodes. Worldwide, the soap opera is the most prominent form of serial dramatic programming. Serialized storytelling can also be seen in other dramas. Heavily serialized dramas include 24, Battlestar Galactica, Dexter, Prison Break, Heroes, Twin Peaks and Lost. Series such as Alias, Angel, Buffy the Vampire Slayer, Veronica Mars, The Good Wife and The X-Files fall somewhere in-between, featuring a new case each week that is solved by the end of the episode, but also having an over-arching mystery that receives focus in many episodes.

As used herein, the term Documentary films constitute a broad category of nonfictional motion pictures intended to document some aspect of reality, primarily, but not limited to, for the purposes of instruction or maintaining a historical record.

As used herein, the term Animation Film indicates a film consisting of a photographed series of drawings, objects, or computer graphics that simulates motion by recording and or creating, very slight, continuous changes in the images, frame by frame.

As used herein, the term Non-fiction (or nonfiction) is the form of any narrative, account, or other communicative work whose assertions and descriptions are understood to be fact.

As used herein, the term Advertising is a form of communication used to encourage or persuade an audience (viewers, readers or listeners) to continue or take some new action.

### STATEMENT OF THE PROBLEM AND PRIOR ART

There are presently several-problems related to the production of various types of media production. The term media production, as used herein, may refer for example, but not limited to, feature length movies, low budget movies, short film, documentaries, animation films or tv-series, that the present invention will solve throughout the exploitation of new advertising opportunities.

Such problems are the following:
High production costs, high investment risk, and a high instance of financial failure: this issue makes the media production industry a capital intensive although highly risky business.
Movie Piracy: Piracy subtracts enormous amount of profits from the entertainment business. As used herein, the term Movie Piracy is the illegal copying of movies for personal or commercial use.
The audience does not want to pay for entertainment anymore: 70% of online users find nothing wrong with online piracy (source Go-Globe.com). As used herein, the term audience is a group of people who participate in a show or encounter a work of art, for example a theater play or a feature film.
Standard media productions duration: to be programmed in theaters or on tv, media productions have to meet certain fixed duration standards, but not all stories have the same length. However, unless they meet these standards, features with non standard length won't be seen because they don't fit in the programming schedule (e.g. Short films)
Lowbudget media productions financial lack of efficiency: this issue hinders filmakers wanting to expose themselves by exercising their talent creating low cost media productions.
An old fashioned distribution system method: this issue makes it complicated or expensive for media productions to get access to the audience and keeps outsiders out of the business. As will be explained later, this is arguably due to the fact that a limited number of major studios supply the 86% of tv and theaters's media productions.
   The opportunity is the following:
Advertising industry in search of new media: the ad companies and their clients are in constant search of new ways to promote their businesses and the present invention itself may be used as an advertising media.

### High Production Costs, High Investment Risk, and a High Instance of Financial Failure.

The movie industry comprises of a process, which may slightly vary from country to country, where a film is created by media producers and then shown to the general public in movie theaters across the world. The process, for example in the case of a feature film, begins with a screenplay; this is the creative thoughts of an individual put down into words, of what they see being made into a film. An individual takes their thoughts placing them on a document and begins to write a screenplay.

Upon completion of the screenplay, the screenwriter at first would seek an agent. An Agent is an individual who is familiar with the financing of the film industry and has contacts with other individuals in the industry, and, for a percentage of the sale, the agent will seek the interest of a producer or movie studio. A movie studio is a company whose job it is to seek screenplay's that they believe would produce revenue from a film's audience once produced. A movie studio has the means to finance, produce and distribute a finished film.

The film community over the years has relied on three consistent methods of financing these projects. The first and most common is a producer who would seek a screenplay that he/she would like to see made into a production. The producer is an individual who knows the film business and has contacts with individuals who can assist in the financing of the screenplay and transform it into a media production.

After completion of a film budget, which is the amount of money needed for its production, it is the job of the producer to raise the necessary funds required by the budget. Traditionally, the producer is limited to three main sources of funds. The first and most relevant in the film industry is to seek investors who would own a percentage of the film and subsequent profits from the film in return for their investment.

The commitment of a respected producer to produce a particular screenplay would generally be to increase the value of the screenplay to investors by securing talent or attachments to the screenplay. This process is called “packaging”. To do this, a producer would present the screenplay to producers, actors and directors who would see the value of the screenplay and become attached to the project. Attachment is a means by which an actor, a producer or a director states that if the film is financed, they would be the director or actor in the film. Sometimes they are paid or guaranteed revenue for this attachment even if the film budget is not raised.

With the increased value of the screenplay due to the attachments, the producer would continue to seek investor funding based on the potential of the project. If the producer can convince enough investors to raise the funds of the budget of the project, they can begin production of the film.

The second way a producer can seek funding is to pre-sell the screenplay to a sales agency. A sales agency or distributor is someone who based on the screenplay and/or any attachments, sees the value of the project and will pay revenue to the producer to film the project in exchange for the sale rights of the project as it is distributed into the movie theaters.

A third way is that a distributor or sales agent might buy the rights to the project for a specific country, foreign distribution or outright sale of the project. This would all be determined by the producer and the distributor.

The high cost of producing and distributing feature length movies continues to escalate each year. These ever increasing costs create a commensurate increase in risk for movie investors and revenues generated from a movie's distribution are often much less than the cost of production.

A significant percentage of box office failures is largely due to the inability of movie producers to accurately predict the number of tickets that will be purchased. Although various market surveys are presently performed by the movie industry, movie producers have been unable to use these methods to determine what the exact size of the audience for a specific movie will be, and consequently cannot determine whether the number of tickets sold will pay for the cost of production of the movie.

Thus, only a small percentage of movies are now profitable.

Furthermore, even in cases where particular movies turn out to be profitable on paper, filmmakers and film investors are often unable to collect their profit share from the distributors of their movies.

Presently methods for assuring the financial success of a movie, in advance of the movie's production are unknown.

Such methods, especially in the economic crisis the world is experiencing today, are now needed.

There is a need to develop improved processes and methods for producing entertainment projects that provide a predictable economic result, and the costless feature exploitation that the audience now demands.

There is a long-held need in the entertainment industry for more effective means to identify, finance, produce and distribute profitable projects.

For example, with reference to the US motion picture industry, Warner, in 2007, stated that of the approximately six thousand films produced per year, less than one hundred are widely released and only a fraction of the widely released films generate healthy financial returns.

Such prior art based on expert management, forecasts and financial control did not achieve the expected results anymore.

It is evident that present methods are grossly inefficient to identify potentially lucrative projects for financing, and finance and produce products with an acceptable probability of generating an attractive return for investors.

Thus, there is a need for improved methods and systems for handling, selecting, financing, and promoting media productions.

Similar things occur in the case of other types of media productions.

### Movie Piracy

Furthermore movie piracy has today impressive numbers and it seems impossible to suppress.

Piracy eats a large amount of the world movie business revenues, subtracting each year worldwide (2010 datas) nearly 35 billion dollars to the cinema industry and almost half of the audience viewers to the television series (the average LOST tv series tv audience is 10 million viewers and the piracy per episode is 5.9 million downloadings).

The online leak of a pirated, unfinished version of a film, can heavily affects the boxoffice. As used herein the term “online” (also stylized as “on-line”) in general indicates a state of connectivity on the internet.

Hollywood also faces the challenge of protecting digital files that pass through so many hands while in production and post-production.

Below are some facts:
67% of Digital piracy sites are hosted in North America and Western Europe.
Websites hosting pirated content receive more than 146 Million visitors per day.
71,060 jobs lost in the United States every year due to Online Piracy.
$2.7 billion in workers' earnings are lost each year due to Online Piracy.
Movies represent 35.2% of pirated items on the web.
China's 91% online piracy rate makes it the highest in world, followed by Columbia with 90% and Russia with 80% online piracy rate.
22% of all global Internet bandwidth is used for Online Piracy.
   (source: GoGlobe.com “Online piracy in numbers”)

In this document the term bandwidth indicates the available channel capacity, or the maximum throughput of a communication path in a digital communication system, such as the internet.

The prior art included studios' attempts at safeguarding their products against piracy, such as by encoding DVDs with digital watermarks that allow authorities to trace individual copies, aren't enough.

At present there is no movie encryption security system known in the movie industry that can't be bypassed.

So, most important of all, the trend is that piracy is going to become worldwide's most widespread method of entertainment products exploitation.

The Audience does not want to Pay for Entertainment Anymore

Another important fact is that 70% of online users find nothing wrong in online piracy (source: GoGlobe.com “Online piracy in numbers”)

This, as the movie piracy trend shows, means that the audience does not want to pay anymore for any kind of media production viewing, just like it is in the free to air (FTA) tv case, also known as traditionally broadcasted television.

The result of the strategies against movie piracy, sponsored by the world wide film industries and associations were not satisfying as the piracy numbers may confirm.

### Standard Media Productions Duration

To be programmed in theaters or on tv, media productions have to meet certain fixed duration standards, but not all stories have the same length. However, unless they meet these standards, media productions with non standard lengths will not be viewed as they don't fit in the programming schedule (e.g. Short films)

Short movies, which are fundamental to identify new actors and directors, have difficulty raising money in the present movie economic system. This makes it hard to advance beyond the screenplay phase because they are never profitable as they usually have no market.

The prior art for Selling short films is difficult. Short films are usually produced with no broadcast audience in mind or with any input from television programmers or marketers who are able to “place” the film in a particular timeslot.

Most short films, however worthy, will never attract festival attention, or a television sale, let alone a theatrical release.

For the short film distributor finding a home for a non-saleable film can mean financial disaster.

Distributors or sales agents will prefer to pick up short films that are under 10 mins, funny and award-winning to exploit in every media worldwide. The standard commission is between 35%-50% of all revenue after costs.

### Lowbudget Movies Financial Lack of Efficiency

So-called “low budget” motion picture projects, also have difficulty raising money.

If a project does receive sufficient financing to produce a film, the film is only rarely profitable to the film producer and investors, even if the film succeeds in making money for distributors and exhibitors of the films. Nevertheless, certain low-budget films have produced spectacular financial results.

At present after a low budget film has participated in festivals and garnered some recognition (or not), it should be time to look at distribution, although the competition for films is very high in any big market, and to get a TV distributor to even look at your film can be a challenge.

It might be unconventional, experimental or maybe too long for a standard programming slot or not of the standard they are looking for in the short term.

The traditional distribution model requires a large marketing investment in materials such as posters, flyers, advertisements on TV and so on.

Alternatives like making your professional DVDs or VODs even for free with companies that will share revenues with you are not a secure way to get your investment back. As used herein the term Video on Demand (VOD) is a system which allow users to select and watch video content on demand.

The method and/or system we are seeking in the present document should also enable producers of entertainment media to readily find the capital that they require to create their art profitably and distribute it to the broadest possibile audience.

### An Old Fashioned Distribution System Method

Distributing an entertainment product, even a big one, is also extremely difficult.

In 2010 the first 6 “Big Six” Hollywood studio majors conglomerates controlled 85.9% of U.S./Can. market share (source Wikipedia), and in detail:
Time Warner (Warner Bros Entertainment) 18%
Viacom (Paramount Motion Pictures Group) 16.8%
News Corporation (Fox Entertainment Group, 20th Century Fox) 14.8%
The Walt Disney Company (Walt Disney Motion Pictures Group) 14.3%
Sony Corporation of America (Sony Pictures Entertainment, Columbia/Tristar Pictures) 12.8% 5
Comcast/General Electric (NBCUniversal) 9.2%.
   (source Wikipedia)

Distribution Conflict of interest situations also arise in which a single film distributor plans to release more than one film at or about the same time, thus dividing the time, skill and efforts of the distributor's marketing staff between such films.

The studio's considerable amount of control over exhibition in key theaters may be used to arbitrarily exclude films from the marketplace thus preventing competition to succeed.

Movie theaters themselves, in the information age, with their non-friendly ergonomicity, their high prices and with their sometimes obsolete projection devices, are outdated.

The way in which this problem was solved was by using new media and new platform releases that had to be paid by the users anyway.

### Advertising in Search of New Media

Advertising expenses are high and the advertising industry is always searching for new advertising media.

Although the global overall expenditure arose (from 2008's 482,125 billion $ to 2012's 492,600 billion $, all the media used are lowering their market share in favor of internet whose quote will rise globally to almost 70%: from 10% in 2008 to 17% forecasted for 2012 (source:Zenith-Optimedia).

Those changes indicates that advertising is always looking for new ways of promoting their clients.

To engage audiences on the growing number of different platforms advertising agencies will increasingly be employing new video opportunities beyond traditional ones like You Tube with Google ADSENSE, VAST and INSPOTs. Google AdSense is a program run by Google Inc. that allows publishers in the Google Network of content sites to serve automatic text, image, video, and rich media adverts that are targeted to site content and audience. These adverts are administered, sorted, and maintained by Google, and they can generate revenue on either a per-click or per-impression basis. VAST, an acronym for Video Ad Serving Template, it is a system that automatically uploads and shows advertising on the web, for example on pre-existing videos. As used herein the term Inspot is a visual advertising tool that consists of the display of a superimposed animation inserted in a program lasting a few seconds, typically in the lower end of the screen (where are usually located the so-called “captions”).

The main prior art, the classic TV advertising model, made of commercials and commercial breaks, went into crisis.

For example, the excess of interruptions during the screening of films, led to the introduction of some limitations. But it is the whole system that was in jeopardy: as an alternative idea, arose television formats with no commercials, but that concept abandoned the idea of free commercial television, to introduce a subscription fee or the pay per view formula.

Those forms of tv always include some sort of payment for the viewer.

An important phenomenon that characterizes and creates problems for the old television advertising is the so-called channel hopping, namely the widespread practice of changing the channel as soon as comes the commercial break, as well as concentrating on something else such as a conversation or simple house work.

Therefore marketers shifted to other advertising formulas.

As used herein, the term Marketer is an individual who operates in Marketing. Marketing is the process which creates, communicates, delivers the value (for example of a product or a brand) to the customer, and maintains the relationship with customers. It generates the strategy that underlies sales techniques, business communication, and business developments.

Branded entertainment: also known as branded content or advertainment, is an entertainment-based vehicle that is funded by and complementary to a brand's marketing strategy.

The purpose of a branded entertainment program is to give a brand the opportunity to communicate its image to its target audience in an original way, by creating positive links between the brand and the program.

These projects are often the result of a content partnership between brands, producers and broadcasters.

Since the 1960s programmes have normally been funded by a broadcaster and they re-couped the money through selling advertising space around the content. The AFP concept is as old as television itself; the term soap opera is derived from the fact that the original soap operas were in fact funded and produced by soap companies such as Procter & Gamble. It was not until the quiz show scandals of the late 1950s, when particularly aggressive advertisers began rigging game shows to produce a more entertaining product, that the practice fell on the wayside.

Furthermore, as advertisers began to shift to thirty second commercials, the practice began to fade by the late 1990s.

Until then the original model had mostly been eschewed in favor of the modern model, which separates programming and advertising

With the advent of digital recording devices, also known as personal video recorders (PVR's), viewers can choose to record episodes or entire series of their favourite shows and watch them in their own time. Not only does this skew the idea of ‘primetime’, (advertisers being charged a premium for buying spots around the most popular viewing times), but it means viewers can skip the ads altogether.

The recent increase in branded entertainment now known as AFP (Advertiser Funded Programming) is one of the consequences of the fragmentation of media and the decline in the power of the traditional 30-second TV spot.

Advertisers and marketers are going back to the branded entertainment methods of the early television industry to increase the exposure their advertising gets and to create stronger ties between the program and their product.

Advertiser funded programming (AFP), was a method to temporarily overcome this change and means the advertiser pays to integrate their message in the tv programme itself. It includes product placement, sponsorship, naming rights and more recently the actual creation of whole shows from scratch.

The increasing popularity of advertiser branded projects in Britain has also led to an increase in TV executives approaching advertisers to co-develop programme content and to create new relationships between brands, broadcasters and distributors across the entire range of traditional and emerging media platforms.

On a larger scale, the movie industry have embraced this new medium wholeheartedly, most recently with movies such as “Transformers”. This was proven to be a very well thought out effective Brand Integration.

Some sports organizations heavily restrict the use of advertiser funded programming, particularly amateur competitions such as the Olympic Games and the FIFA World Cup, both of which ban the practice as covert advertising. The term Covert Advertising as used herein is the practice of achieving an indirect publicity of the product by advertising it through movies and TV shows. TV actors and characters in movies are often shown using certain products. Covert advertising is an indirect way of advertising a product by featuring it in films and television shows without the awareness of the viewer.

Other sports have embraced the practice as an additional form of revenue, both for the leagues and the networks.

Naming rights have been sold for bowl games, tournaments, television presentations, halftime shows, stadiums and arenas, while product placements and advertisements can be seen on the fields, on sideboards surrounding them, or as on-screen graphics without interrupting a telecast.

Advertiser funded programming techniques give sports broadcasters a third channel of revenue, in addition to re-transmission consent fees and traditional advertising, allowing stations such as ESPN to pay high rights fees and still make significant amounts of money.

Traditional forms of advertising have become less and less effective in reaching consumers fragmented over hundreds of channels and with the introduction of new methods of delivering programming, such as internet streaming and digital video recording devices. As used herein the term Streaming (short for Data Streaming), commonly seen in the forms of audio and video streaming, is when a multimedia file can be played back without being completely downloaded first.

The difficulties arise when producers must emphasize and understand the balance between entertainment and brand, avoiding covert advertising.

Product placement: the most common way to integrate brands into programming is by using product placement.

Instead of simply using a product as a prop or background filler, the product will be woven into the plot or dialogue of the program.

For this reason, the term brand integration is more commonly used.

The objective is to create a link in the viewer between the program and their product. This is also a guaranteed way for their advertising to be seen, no matter what method the viewer chooses to watch the program in, but some times it can become covert advertising.

But these kinds of ads have to be broadcasted anyway on classical tv channels and cinemas, therefore being not completely free.

Internet Advertising: the only rising media in which the advertising world suffers from the lack of technology standards is the web's video advertising, and this is a concern for the advertising authorities.

In-stream video advertisements, unlike other forms of display or banner ads, execute in the player environment.

Through the VAST system on the internet advertising and similar API (application programming interface) for example we might see on our internet videos:
Clickable Pre-roll: More similar to a normal tv spot, they are Clickable ads in a video pre-roll format, with an additional interactive overlay. The overlay can either be text or an image, and when the user clicks on the ad, they will be taken to a page the advertiser specifies. This page will open in a separate window.
CompanionBanner: This format is a video ad, with the interactive section external to the video player. The video area is not clickable.
Overlay Banner: The overlay format displays the sponsor images over the video during the video playback.
OverlayBanner with click-to-linear videoad: The overlay format displays the sponsor images over the video during the video playback. If the user clicks on the banner, the ad shows a linear video ad followed by the ad disappearing. If the user does not click, the overlay banner displays until its display time has elapsed.

In this document the term application programming interface (API) is a source code based specification intended to be used as an interface by software components to communicate with each other.

### RELATED APPLICATION PRIOR ART

The two patents I have listed before as a prior art, have tried to give a solution to the some of the problems, especially the fundraising problem (US 2006/0259312 Al De Titta Pub. Date: Nov. 16, 2006 entitled “METHODS AND APPARATUS FOR PRODUCING AND FINANCING MEDIA PRODUCTIONS”) and the free for the audience entertainment (US 2006/0026059 Al Feb. 2, 2006 entitled “ADVERTISING METHOD FOR DIGITALLY RENTED MOVIES”) both have several limitations.

The first of the two, US 2006/0259312 De Titta) is a method to finance media productions of various kind by using the advertising revenues sold on another support “designed to generate impressions” to raise the funds that will be employed in a media production fund to produce entertainment of various kinds, but such entertainment it is not meant to be given for free to the audience.

The second of the two (US 2006/0026059 Grosz) is directed to “digitally rented movies” that as it is explained refers to “the act of downloading or streaming movies over the internet for the purpose of viewing for a limited time period or a limited number of times” so it is clearly not intended for movies or media production that can be given or watched for an unlimited number of times on any support.

Furthermore when the purpose of using advertising banners on “digitally rented movies” for the purpose of “making this form of movie rentals cheaper or free for the consumer” the patent still refers to such kind of movies to be seen for cheaper or free for a limited number of times or time period.

Also the kind of movies the patent refers to are the kind “very similar to that found at Blockbuster Video” so we are talking about normal movies, produced in the usual way and not movies developed to be given unlimitedly for free to the public.

After reading both the patents I have herein indicated, their claims and the detail of the following method that I am about to disclose and its claims, the differences among them will be evident to anybody skilled in the art.

### 2D and 3D and the Need for 3D Content

As used herein, the term Stereoscopic, or 3D (three dimensional) film, refers to a film created or shot with processes and devices for giving the illusion of depth.

It is also worth considering that at present in Italy alone, 4.2 million 3D TVs have been sold, but the amount of stereoscopic entertainment available hardly reaches 60 hours, and it is therefore necessary, and lucrative, to produce 3D media production to meet this new market segment.

It would be useful to produce media productions using the present invention in both 2D and in 3D, knowing that to shoot 3D, before now was extremely expensive. Now this is possible thanks to the experience I had in shooting PARKING LOT 3D (released in italian theaters in 2011), to shoot I developed a production process that allowed me, with the same investment necessary to create a 2D media production, I was able to produce a movie in both 2D and 3D. This production process is herein mentioned as an example and or a business opportunity but is not meant to be part of the present invention.

### CONCLUSIONS

The prior art and the prior methods do not provide a solution to the problems discussed above.

It has become apparent to me that the media production's business model itself is no longer working efficiently and therefore it is necessary to find a solution. This will be found in the present invention that I am about to explain.

### SOLUTION TO THE PROBLEM

### Object of the Invention

The methods and systems disclosed in this invention provides a method for producing an entertainment product provided free of charge to the public.

The primary object of the present invention is to produce free media productions for the audience and meant to be provided for free to viewers, with no limitation, other than plagiarism while being financially profitable for all the individuals involved in the productions prior to their release.

As used herein the term plagiarism is the unauthorized use or close imitation of the language, work and thoughts of another author and the representation of them as one's own original work, as by not crediting the author.

A further object of the present invention is create a kind of media production that will be piracy insensitive.

Another object of the present invention is to create a new Advertising media, discretely but evidententely branded with names and logos only, thus not distracting the viewer and not falling into covert advertising.

Furthermore another object of the present invention is to create a solid financial movie system with lower but certain revenue streams that will be paid upfront thus eliminating any boxoffice or tv ratings concerns.

A further object of the present invention is to create a more efficient media production distribution system method.

Another object of the present invention is to solve the Short Movies and Lowbudget movies financial lack of efficiency.

The last object of the present invention is to help fulfill the need for 3D content generated by the diffusion of 3D television systems.

### SUMMARY OF THE INVENTION

The present invention solves the aforementioned problems of the prior art and means an advance in the field by providing a method to produce and finance a new kind of media production which is meant to be provided to the viewers for free and with no limitation, other than plagiarism.

Such method at the same time will be financially rewarding for the production company, or companies, and the individuals involved in the production prior to the feature's free release, by selling one or more screen portions of the viewing area of the feature to companies or individuals that wish to indeleably watermark, with various levels of opacity, their name or logo or both on the screen.

This will also mean that the financial success of the media product is therefore obtained at this stage, so there will be no boxoffice or tv ratings concerns because the initial production fee, obtained from the sale of screen portion, is meant and will be the only financial revenue of the feature.

The actual realization of the media production is not commenced until the number of screen portions sold is sufficient to cover the estimated cost of the media production.

Considering the relatively small size, and variable opacity of the logos to the size of the entire screen viewing area, the interference with the media production will be minimal. Although the focus of the spectator will be directed to the media production, the logos and the names will be perceived from the spectator's casual viewing.

Furthermore, the new kind of media production produced using the method disclosed in the present invention, being free for the audience, and therefore having no programming or boxoffice constraints, won't need to have a standard duration.

It will therefore be possible to choose the media production that we want to watch also based on its duration.

Therefore the method disclosed in the present invention comprises, not necessarily in the following order, the steps of:

a. selecting a media production to be produced, including but not limited to Feature films, series, episodes of series, animation films, short movies, documentaries;
b. developing a budget for the production costs of the selected media production, comprehensive of the production company or companies production fee or fees, which will be the total amount to be collected from the one or more screen portion sales;
c. developing a “Project Package” by binding the artistic cast and/or the technical cast, the subject and/or the story and/or the screenplay of the yet-to-be-produced media production determined in step “a” and “b” through the use of contracts and/or agreements with the involved parties, a step of the method that those skilled in the art will be able to devise;
d. presenting of the aforementioned package to companies that may or may not be interested in buying the one or more screen portions of the media production as described in step “a”, through the use of one or several media production presentation means including but not limited to synopsis, selected scenes storyboarding, animatic and so on, a step of the method that those skilled in the art will be able to devise;
e. completing the one or more available screen portions sales, so that the revenues from such sales are sufficient to cover the estimated cost of the media production determined in step “b” and the revenues, from such sales which will be included into a media production fund which will include the media production budget and the profits thereof for the companies and individuals involved in the production;
f. Realization of the media production, making sure that after principal photography, or even in this phase in the case of animation films, each and every footage used in post production will always have logos and/or names of the companies and/or individuals that bought the screen portion/s of the screen indeleably watermarked;
g. Releasing the media production on the internet or by any other mean so that the feature will be uploaded at first on the main production company web hub and then released for free on the internet, to be downloaded or streamed for free by anybody wishing to do so, encouraging its free circulation on other web platform kinds, including but not limited to torrents, peer to peer platforms, media content providers, streaming tv with no limitations other than plagiarism.

As used herein a torrent is a group of computers sharing a file or files using the BitTorrent protocol. In a torrent each computer simultaneously downloads parts of a file from many other computers, and also uploads copies of those parts to other computers. Because each computer in a torrent shares data with its peers, large files can be widely and efficiently distributed.

As used herein the term peer-to-peer describes applications in which users can use the Internet to exchange files with each other directly or through a mediating server.

The various objects and advantages of the present invention will be more readily understood from the following detailed description when read in conjunction with the appended figures and workflow illustrations.

### BRIEF DESCRIPTION OF THE DRAWINGS

The preferred embodiment is illustrated in the figures of the accompanying drawings by way of example, and not limitation, in which:

FIG. 1 a flow diagram of an exemplary embodiment of the general workflow of the method disclosed in the patent is illustrated.

FIG. 2 an exemplary embodiment of the screen with a few watermarked logos in the viewing area is illustrated.

### DETAILED DESCRIPTION

In some instances, the methods of the present invention are claimed and described herein as a series of treatment steps. It should be understood that these methods and associated steps may be performed in any logical order. Moreover, the methods may be performed alone, or in conjunction with other procedures before, during or after such methods and steps set forth herein without departing from the scope and spirit of the invention.

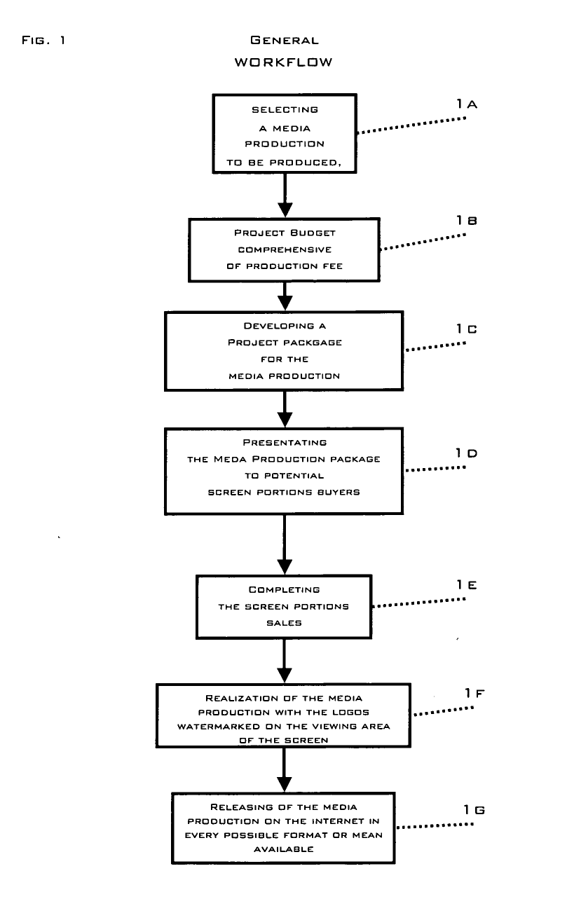

In FIG. 1 the general workflow of our method is illustrated. Those skilled in the art may easily understand the meaning of the steps indicated in the single blocks which the present method comprises, but not necessarily in the following order.

Block 1A indicates the step of selecting a media production to be produced, including but not limited to Feature films, series, episodes of series, animation films, short movies, documentaries;

The workflow of step 1A is self explanatory to those skilled in the art: it will just be a matter of choosing among various types of media production to be produced, including but not limited to Feature films, series, episodes of series, animation films, short movies, documentaries basing such decision on e.g. genre, and/or topic, and/or screenplay, and/or duration.

Block 1B indicates the step of developing a budget for the production costs of the selected media production, comprehensive of the production company or companies production fee or fees, which will be the total amount to be collected from the one or more screen portion sales. The workflow of block 1B of figure one is here explained. Those skilled in the art may easily understand the meaning of the steps indicated in the single blocks which the present method comprises, but not necessarily in the following order:
Analyzing the cost of the media production chosen to be produced. Those skilled in the art may easily understand the meaning of this step.
Determining a production fee, which is a delicate step because this is the main and/or only lawful profits that will come from the media production.
Determining in how many languages the media production is going to be dubbed, subtitled and the costs of such an operation.
Analyzing the cost of the media production release through the internet, e.g. the web page expenses, the poster image, the press office, the bandwidth use expenses and other steps that those skilled in the art may easily determine.
Summing up the costs of the precedent steps and therefore determining the value of the screen space which will be sold to one or more companies or individuals which wish to watermark their names and or brands on it for such a fee.

Block 1C indicates the step of developing a “Project Package” by binding the artistic cast and/or the technical cast, the subject and/or the story and or the screenplay of the yet-to-be-produced media production determined in step “1A” and “1B” through the use of contracts and/or agreements with the involved parties, a step of the method that those skilled in the art will be able to devise. Packaging is the process of assembling several creative elements director-producer or star or any combination with the screenplay offered to a financing source in order to enhance the transaction.

Block 1D indicates the step of presenting of the aforementioned package to companies that may or may not be interested in buying the one or more screen portions of the media production as described in step “1A”, through the use of one or several media production presentation means including but not limited to synopsis, selected scenes storyboarding, animatic and so on, a step of the method that those skilled in the art will be able to devise.

The cost of the screen portion for example might depend on the position requested, the number of logos present on the frame: the more favourable the position and/or the less number of logos, the higher the price of the screen portion/s.

When the screen space on a particular media production is highly requested it might also be possible to sell the screen space even through auctions.

Block 1E indicates the step of completing the one or more available screen portions sales, so that the revenues from such sales are sufficient to cover the estimated cost of the media production determined in step “1B” and the revenues, from such sales which will be included into a media production fund which will include the media production budget and the profits thereof for the companies and individuals involved in the production. Production of the movie is not commenced until the number of ‘“screen surface”’ sold is sufficient to cover the cost of making the movie which includes the producer's fee.

The completion bond might be added to the package to ensure to clients the delivery of the final product. As used herein a completion bond (sometimes referred to as a completion guarantee) is a form of insurance offered by a completion guarantor company (in return for a percentage fee based on the film's budget) that is often used in the film industry to guarantee that the producer will complete and deliver the film (based on an agreed script, cast and budget) to the distributor(s), in the present document case the audience, thereby obtaining the desired visibility effect.

Block 1F indicates the step of the actual realization of the media production, making sure that after principal photography, or even in this phase in the case of animation films, each and every footage used in post production will always have the logos and/or names of the companies and/or individuals that bought the screen portion/s of the screen indeleably watermarked.

This step of the method is about producing the media production. This step, for those who are skilled in the art may devise, is made of three main parts: pre production, principal photography and post production. It is very important to make sure that after principal photography, or even in this phase in the case of animation films, each and every footage used in post production will always have the logos and/or names of the companies and/or individuals that bought the screen portion/s of the screen indeleably watermarked.

It is also important that in this or any other step in which watermarked free footage and or images will be present, the environment must be internet connection free and the person/s that will deal with such footage must be limited to the minimum. Furthermore those individuals will have special agreements that will guarantee their correct behavior, such as for example, and not limited to, not bringing any kind of device able to copy or transmit any part of the watermark free material during those working sessions.

In the 3D (stereoscopic) media production case the logos will be set at the screen plane depth level with the action underneath so that such logo frame will not interfere with the 3D perception. The convergente adjustments of the whole footage are made at this time. The Convergence or Convergence Plane, is the distance where the two cameras converge to place an object at the plane of the screen during projection. Also referred to as the zero plane, zero parallax point or screen plane, and more particularly is the position in a theater where the projection surface is located; a vertical plane coinciding with the screen that helps define where objects appear in front of, behind, or on the screen. Such positions can be adjusted through use of various types of software that those skilled in the art will easily devise.

The production company will have contractual agreements for the acceptance of the presence of logos on the screen for actors and authors.

For example, the director of the feature is the creative force that pulls a film together but he will have no authority over the kind of logos or their order positioning or their presence on screen

To watermark such logos on the screen portions, several softwares, that are well known to those skilled in the art, might be used; in the case of a non-digital film, an optical printer might also be used.

A logos clean media production must not exist when produced with the method of the present invention: that is why the non watermarked use must be limited and treated in a secure environment, as previously mentioned.

However, the production of entertainment and media often involves contributions from numerous individuals, particularly for sophisticated projects.

High risk of leaked images exists from the producers standpoint because each feature has 50 to 500 people involved in the process, so it becomes important to control the info flow throughout the entire production.

So, to ensure the constant presence of the logos on the screen, starting from the set, the original files or film after shooting, will be taken and the logos watermarks will be printed on it.

The logos will be on screen also during the editing process.

The only step in which the logos are taken off is the one moment of low security which will be done in house for updating logos, for color grading, or for the final convergente adjustment in case of a 3D media production.

Those steps will be done by color grading projects in-house rather than relying on editing companies in order to avoid the leaking of clear (logos free) material, and all the procedures of adding logos should be done directly in the production company's facilities.

As previously mentioned in this or any other step in which watermarked free footage and or images will be present, the environment must be internet connection free and the person/s that will deal with such footage must be limited to the minimum. Furthermore those individuals will have special agreements that will guarantee their correct behavior, such as for example, and not limited to, not bringing any kind of device able to copy or transmit any part of the watermark free material during those working sessions.

This will make sure the constant visibility of the screen surface buyers' logos on the screen.

Block 1G indicates the step of releasing the media production on the Internet or by any other mean. This is the moment in which the feature will be uploaded on the internet. For example this step could be accomplished by a main website which will release the media production. As used herein, the term website is a set of related webpages containing content (media), including text, video, music, audio, images, etc. A website, accessible via a network such as the Internet.

This web site will only be the source of the free media production produced with the present method because, from that moment on, it will be spread for free encouraging its free circulation on other platforms types, including but not limited to torrents, peer to peer platforms, media content providers, steaming tv with no limitations other than plagiarism.

Furthermore, duration of features will not have to be fixed because there won't be a ticket or a tv programming schedule, so, on this web hub, it should be possible to choose the feature that we want to watch also based on its duration.

For those who instead want the experience the crowd this method might also give birth to the phenomenon of free social Movie Watching through the creation of sponsored cinemas where the free media productions, produced with the present invention, are featured.

In the case of the presence of a main web hub, which might be sponsored by more banners, the audience will be able to watch the movies streaming, download 2d and 3d versions of them, download the English, Italian and subtitled versions.

On such main web hub the entire free feature entertainment production, with the watermarked logos, might be kept and updated, together with special features and more recent releases.

Co-marketing of funding companies will ensure initial knowledge of the produced movie existence, therefore allowing people to download it and enjoy it. Co-marketing with advertising sponsors to promote the various releases.

Due to the progress in technology, people may see movies at home through the web directly in their television sets. The user may choose download the needed Data, the movie, through a time shift watching platform.

Copyrights issues of the media production illustrated in the present invention might be treated as a commercial, but anyway all the artists involved in the production, e.g. the music composer, will be asked to renounce the music rights for a fixed fee.

With regard to SIAE for example (Società, Italiana, Autori ed Editori, the Italian authors guild) the rights will be administered under Article 11 of the general SIAE regulations which accepts the free circulation of authorial products, if the authors agree, under certain circumstances, as long as its diffusion is free of charge for the audience as in the case of the present invention.

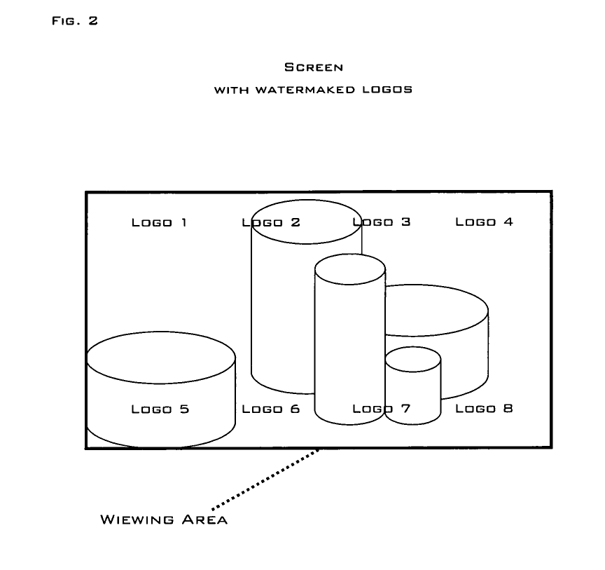

In FIG. 2 a screen example of a media production produced with this method is illustrated. We see a rectangle, which is the viewing area of our media production, inside of which we see some cylinders that represent the images of the feature, and a series of 8 logos watermarked on the screen. Such logos can be of steady or variable opacity. They are always present on the screen during the whole movie so that the will not interfere with the editing process. For the same reason it is preferable that they are still and not animated.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

As in the rest of the document the term media production, may refer for example, but not limited to, feature length movies, low budget movies, short film, documentaries, animation films or tv-series, that the present invention will solve throughout the exploitation of new advertising opportunities.

1-9. (canceled)

10. A method for producing and financing a media production so as to allow viewers free access to the media production while financially rewarding a production entity responsible for making the media production prior to release of the media production, said method comprising steps of:
(a) selecting a media production to be produced;
(b) developing a budget for the media production including costs of the media production, and comprehensive fee for the production entity, to obtain an estimated cost with pre-set profit;
(c) developing a “Project Package” by binding artistic cast and/or technical cast, subject and/or story rights of the media production through agreements with involved parties;
(d) presenting of the “Project Package” to companies and/or individuals that may be interested in buying one or more screen portions of the media production for displaying logo(s) and/or name(s);
(e) completing sales of the one or more screen portions, so that revenue from such sales are sufficient to cover the estimated cost with pre-set profit of the media production as determined in step (b);
(f) realization of the media production including providing in each footage of the media production as indelible watermarks the logo(s) and/or name(s) of the companies and/or individuals that bought the one or more screen portions of the media production;
(g) releasing the media production for free Internet access or to a distribution company web hub for subsequent release for free via Internet for downloading or streaming view and allowing for free circulation by other web platforms.

11. A method according to claim 10 further comprising selecting suitable name(s) and/or logo(s) for screen portions based on story and/or genre and/or theme and/or other potential name(s) or logo(s) that are to be indelibly watermarked on the one or more screen portions.

12. The method according to claim 10 further comprising including in the “Project Package” a completion bond as an additional guarantee of completion of the media production.

13. The method according to claim 10, wherein opacity of the indelible watermarks variates on the screen portions during running of the media production.

14. The method according to claim 10, wherein in step (f), after editing is completed, original clean film of the media production is recouped and color corrected and the name(s) and logo(s) are indelibly watermarked again to revise or add to the name(s) and logo(s).

15. The method according to claim 10, wherein in step (f), after editing is completed, original clean film of the media production is recouped and color graded and the name(s) and/or logos are indelibly watermarked again to provide color grading thereto.

16. The method according to claim 10, wherein the media production is in 3D, and in step (f) all convergence adjustments are made before editing is completed and before watermarking of the name(s) and logo(s) occurs for a second time.

17. The method according to claim 10, wherein the media production is in 3D, and in step (f) after editing is completed, original clean film of the media production is recouped and convergence adjustments are made before watermarking the name(s) and logo(s) occurs a second time.

18. A media production on which at least one of a company's name(s), logo(s) and advertisement(s) are indelibly watermarked on screen space.
